(19) United States
(12) Patent Application Publication
(10) Pub. No.: US 2013/0088569 A1
(43) Pub. Date: Apr. 11, 2013

(54) APPARATUSES, METHODS AND SYSTEMS FOR PROVISION OF 3D CONTENT OVER A COMMUNICATION NETWORK

(71) Applicant: Keith Fredericks, New York, NY (US)

(72) Inventor: Keith Fredericks, New York, NY (US)

(73) Assignee: GLOBAL DEVELOPMENT HOLDING LTD., New York, NY (US)

(21) Appl. No.: 13/270,161

(22) Filed: Oct. 10, 2011

(51) Int. Cl. H04N 13/00

(52) U.S. Cl. 348/43; 348/E13.002

(57) ABSTRACT

The APPARATUSES, METHODS AND SYSTEMS FOR PROVISION OF 3D CONTENT OVER A COMMUNICATION NETWORK (“3D-WCP”) implement on-demand client-independent network streaming of three-dimensional (“3D”) media content. In one embodiment, a 3D media streaming processor-implemented method is disclosed, comprising: obtaining a three-dimensional display media object encoded in a camera-dependent media format; transcoding via a processor the obtained display media object into a transcoded three-dimensional display media object encoded in a device-independent scalable media format; obtaining a request for the transcoded three-dimensional display media object from a client device; and streaming the transcoded three-dimensional display media object to the client device.

### CROSS-REFERENCE TO RELATED APPLICATIONS

The present patent application is a non-provisional of, and claims priority from, the co-pending U.S. Provisional Patent Application Ser. No. 61/378,876, entitled “APPARATUSES, METHODS AND SYSTEMS FOR A 3D WEB CONTENT PROVIDER”, filed on. Oct. 8, 2010.

### FIELD

The present invention is directed generally to apparatuses, methods, and systems of Internet streaming media, and more particularly, to APPARATUSES, METHODS AND SYSTEMS FOR PROVISION OF 3D CONTENT OVER A COMMUNICATION NETWORK.

### BACKGROUND

Users may consume media content including videos from the Internet. For example, users may watch streaming video of television shows and movies from Hulu.com. Users may upload, share and view each other's videos on YouTube.com.

### SUMMARY

The APPARATUSES, METHODS AND SYSTEMS FOR A 3D WEB CONTENT PROVIDER (“3D-WCP”) implement on-demand client-independent network streaming of three-dimensional (“3D”) media content.

In one embodiment, a 3D media streaming processor-implemented method is disclosed, comprising: obtaining a three-dimensional display media object encoded in a camera-dependent media format; transcoding via a processor the obtained display media object into a transcoded three-dimensional display media object encoded in a device-independent scalable media format; obtaining a request for the transcoded three-dimensional display media object from a client device; and streaming the transcoded three-dimensional display media object to the client device.

In one embodiment, a 3D media consumption processor-implemented method is disclosed, comprising: providing a request for a network resource; obtaining a web page in response to providing the request for the network resource; parsing the obtained web page for rendering a display for a user; identifying a reference to a three-dimensional display media object in the web page based on parsing the web page; providing a request for the referenced three-dimensional display media object; obtaining a stream comprising media from the three-dimensional display media object, the stream encoded according to a device-independent scalable media format upon providing the request; and providing a three-dimensional projection using the obtained stream.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

The accompanying appendices and/or drawings illustrate various non-limiting, example, inventive aspects in accordance with the present disclosure:

FIG. 1 is of a block diagram illustrating exemplary aspects of the 3D Web Content Provider (“3D-WCP”);

FIG. 2 is of a data flow diagram illustrating exemplary aspects of implementing on-demand client-independent network streaming of three-dimensional (“3D”) media content in some embodiments of the 3D-WCP;

FIG. 3 is of a logic flow diagram illustrating exemplary aspects of transcoding camera-dependent 3D into a device-independent scalable media format in some embodiments of the 3D-WCP, e.g., a 3D-media transcoding (“3D-MT”) component;

FIG. 4 is of a logic flow diagram illustrating exemplary aspects of on-demand client-independent network streaming of three-dimensional (“3D”) media content in some embodiments of the 3D-WCP, e.g., a 3D-media streaming (“3D-MS”) component;

FIGS. 5A-B are of logic flow diagrams illustrating exemplary aspects of optimizing settings of a client-side streamed 3D media display in some embodiments of the 3D-WCP, e.g., a 3D-media display optimization (“3D-MDO”) component;

FIG. 6 is of a block diagram illustrating embodiments of the 3D-WCP controller; and

APPENDICES A-F illustrate alternate embodiments and further inventive aspects of the 3D-WCP.

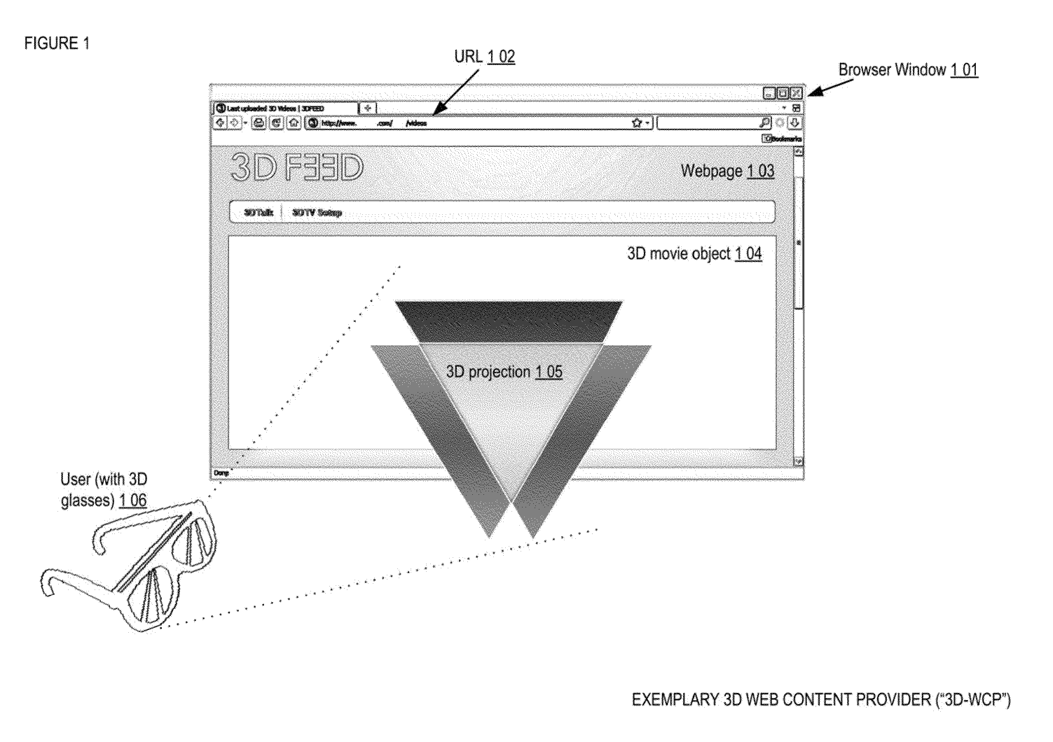

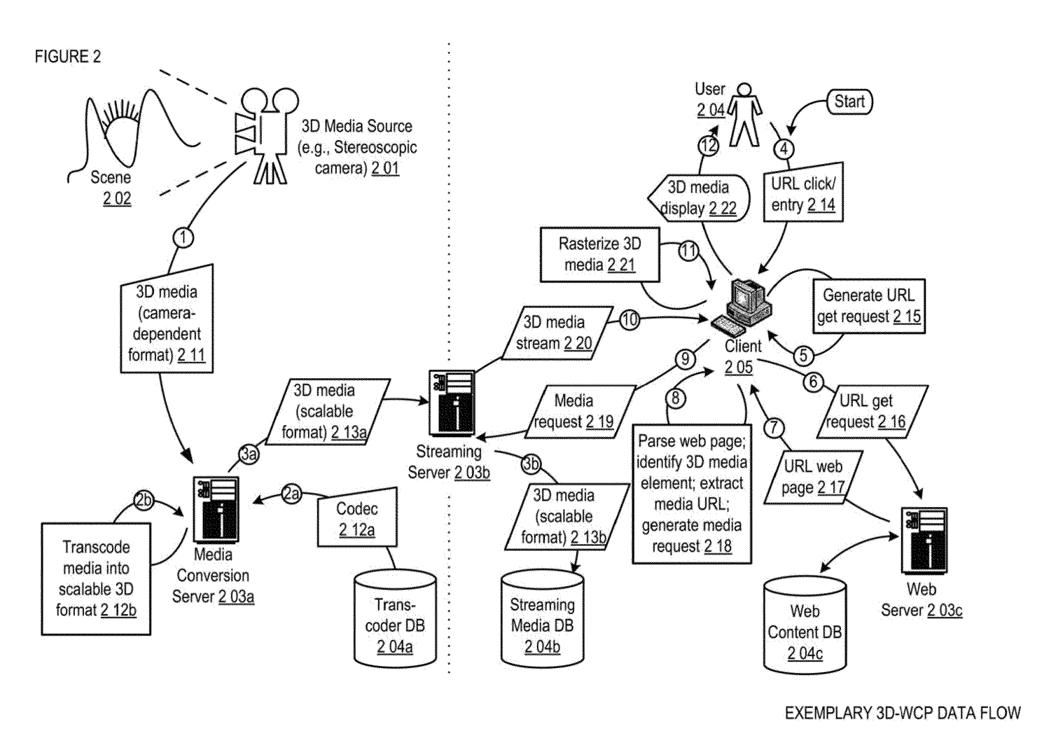

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### 3D-Web Content Provider (3D-WCP)

FIG. 1 is of a block diagram illustrating exemplary aspects of the 3D Web Content Provider (“3D-WCP”). In some implementations, the 3D-WCP enables on-demand client-independent network streaming of three-dimensional (“3D”) media content. For example, a user may be operating a client device (e.g., laptop, smartphone, etc.) including a web browser application. The web browser application may include one or more browser windows and/or tabs, e.g., 101. The user may manually type in a Uniform Resource Locator (“URL”), e.g. 102, into a browser location bar of the web browser application. Alternatively, in some implementations, the browser window may be displaying a web page to the user, e.g., a HTML web page. The web page may include a hyperlink to a URL. The user may activate (e.g., click) on the hyperlink to redirect the browser to the URL associated with the hyperlink. Upon obtaining the web page, e.g. 103, the browser application may display the contents of the web page for the user. In some implementations, the web page may include a three-dimensional (“3D”) movie object, e.g., 104, embedded into the displayed web page. In such implementations, the client device may request a server to stream the 3D movie for displaying to the user. The server may stream the 3D movie to the client device in response to the request. The client device may rasterize the streamed 3D movie, and display the rasterized 3D movie for the user, e.g., 105. The user may, in some implementations, observe the 3D movie using 3D glasses, e.g., 106. In other implementations, the user may be able to visualize the movie without visual aids (e.g., in the case of autostereoscopic 3D content).

FIG. 2 is of a data flow diagram illustrating exemplary aspects of implementing on-demand client-independent network streaming of three-dimensional (“3D”) media content in some embodiments of the 3D-WCP. In some implementations, the 3D-WCP may enable real-time streaming of live 3D media content generated on-the-fly. For example, in some implementations, a 3D media source 201 (e.g., stereoscopic/multi-view camera, smartphone with two cameras/stereoscopic camera, etc.) may capture 3D media representative of a scene 202. For example, a user may be utilizing a smartphone/tablet computer/laptop client device within a videoconferencing session, and the user may utilize the camera system on the client device to obtain the 3D media. The 3D media source may capture the 3D media in a source-dependent format, e.g., left and right eye view intermixed into a movie format such as MPEG-4. In some implementations, the 3D media source may generate a 3D movie file, e.g., 211, and transmit the file to a media conversion server, e.g., 203a. In alternate implementations, the 3D media source may stream the movie as it is being generated, e.g., via Real Time Streaming Protocol (RTSP)/Real Time Transport Protocol (RTP), to the media conversion server. Upon obtaining the 3D media file/stream, the media conversion server may transcode, e.g., 212b, the obtained 3D media from the source-dependent format into a device-independent 3D scalable media (“SMF”) format. For example, the media conversion server may transcode the obtained 3D media from the source format into the scalable media format, for example, such as described in Appendix F. The media conversion server may utilize transcoding rules and/or codecs 212a from a transcoder DB to transcode the obtained 3D media fro the source-dependent format into the SMF format. In some implementations, the media conversion server may transfer/stream, e.g., 213a, the transcoded SMF format media file/data to a streaming server, e.g., 203b. The streaming server may store 213b obtained 3D media files encoded in the SMF format to a streaming media database, e.g., 204b, and.or may store 3D SMF-encoded media data in a buffer for live real-time on-demand streaming to a user's client device.

In some implementations, a user, e.g., 204, may wish to consume 3D media content stored on the streaming server and/or streaming media database. The user may operate a client (e.g., 205) including a web browser application. The user may, for example, manually enter, e.g., 214, a URL into a browser location bar of the web browser application or activate a hyperlink to redirect the browser to a URL associated with the hyperlink. In response, the client may generate, e.g., 215, a URL get request, and provide the URL get request, e.g., 216, to a web server, e.g., 203c. For example, a browser application executing on the client may provide, on behalf of the user, a (Secure) Hypertext Transfer Protocol (“HTTP(S)”) GET message for a HyperText Markup Language (“HTML”) page. An exemplary HTTP(S) GET message that may be provided by a browser executing on the client to request an HTML, page is provided below:

GET /video.html HTTP /1.1
From: username@3dfeed.com
Host: www.3dfeed.com
User-Agent: Mozilla/4.0

The web server may obtain the request, and retrieve a web page associated with the requested URL from a web content database, e.g., 204c. The web server may provide the URL web page, e.g., 217, to the client. In some implementations, the URL web page may include a reference to a 3D media element. For example, the URL web page may include HTML/JavaScript™ commands to embed a 3D media in a HTML5 canvas element. For example, the JavaScript™ commands may include Web Graphics Library (WebGL) standards-based application programming interface (“API”) call to utilize the hardware graphics processing capabilities of the client. Exemplary HTML/JavaScript™ commands to reference a 3D media element are provided below:

<!DOCTYPE HTML>
<html>
<div class=“content clearfix”>

<script src=“http://www.media.com/files/js/webGL_3D_2.0.js”
type=“text/javascript” charset=“utf-8”></script>
<script type=“text/javascript” charset=“utf-8”>window.onload =
function( )
Video3DGeneral.setup( );</script>
<link rel=“stylesheet”
href=“http://www.media.com/files/css/video-3d-
feed.css” type=“text/css” media=“screen” title=“Video 3D Feed”
charset=“utf-8”>

<div class=“video-3d-box”>

<canvas class=“video-3dg” id=“vidl” v3d_autoplay=“off”

width=“640”
height=“360”
v3d_src=“http://www.media.com/files/movie.webm”
v3d_inputmode=“STEREO_Q”
v3d_outputdev=“SBYS”
v3d_poster=“http://www.media.com/files/Poster.jpg”>

</canvas>

</div>

</div>
</html>

In some implementations, the client may obtain the web page, parse the web page to identify any embedded media. Upon identifying the embedded 3D media based on the parsing of the web page, the client may generate a media request for the 3D media. The client may send the media request 219, e.g., via a HTTP(S) GET request, to the streaming server. Upon obtaining the media request, the streaming server may provide the buffered SMF-formatted 3D media stream and/or file, e.g., 220, stored in the streaming server and/or streaming media database. For example, the streaming server may provide the SMF-formatted 3D media stream and/or file via HTTP(S) streaming to the client. Upon obtaining the 3D media stream, the client may rasterize the obtained 3D media. For example, the browser application executing on the client may make a WebGL API call to the hardware graphics processing unit (“GPU”) of the client. In response the GPU of the client may rasterize the obtained. SMF-formatted 3D media according to the requirements of the display device connected to the client. The client may provide the rasterized 3D media to the display device connected to the client, and the display device may provide the 3D media content, e.g., 222, for the user.

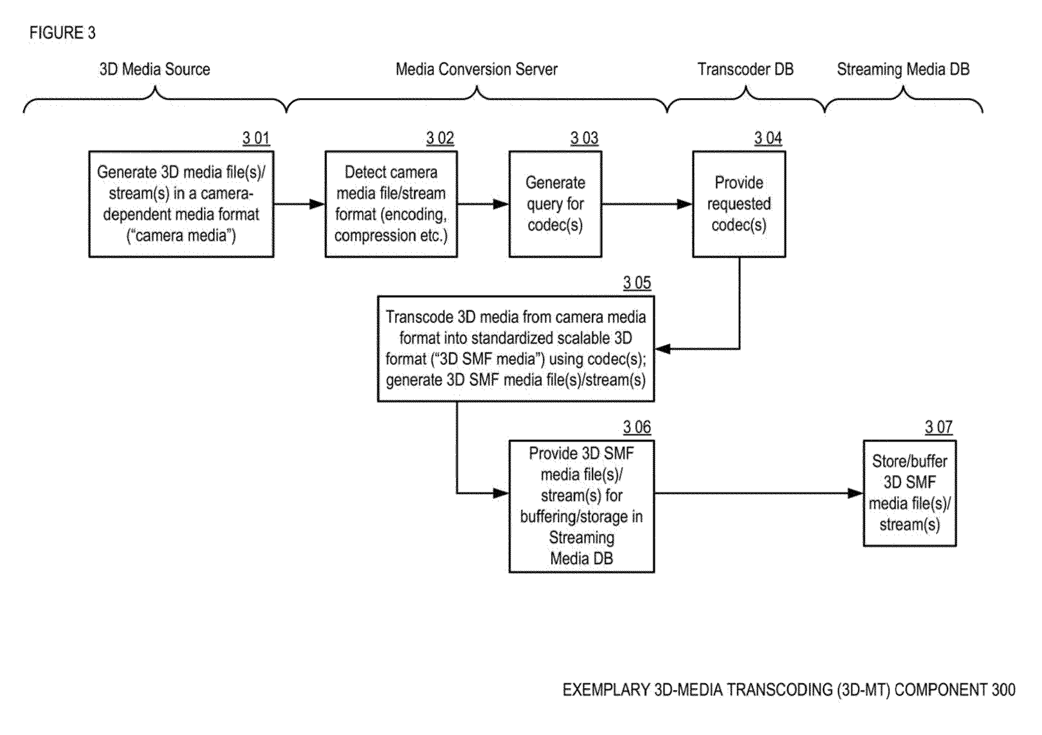

FIG. 3 is of a logic flow diagram illustrating exemplary aspects of transcoding camera-dependent 3D into a device-independent scalable media format in some embodiments of the 3D-WCP, e.g., a 3D-media transcoding (“3D-MT”) component 300. In some implementations, a 3D media source may generate 301, via smartphone, stereoscopic/multi-view camera(s) etc., 3D media file(s)/stream(s) in a camera-dependent media format (“camera media”). The 3D media source may transmit, e.g., via File Transfer Protocol (“FIT”), HTTP(S) streaming, etc., the camera media to the media conversion server. The media conversion server may obtain the camera media, and may detect 302 the file/stream format of the camera media (e.g., encoding, compression, etc.). For example, the media conversion server may obtain camera media may include header information including, but not limited to: compression, encoding, number of streams, number of channels, and/or the like. The media conversion server may query 303 the transcoder database for a codec based on the header information. For example, the media conversion server may execute a Hypertext Preprocessor (“PHP”) script including Structured Query Language (“SQL”) commands to interface with a relational database management system (“RDBMS”). An exemplary listing, written substantially in the form of PHP/SQL commands, illustrating substantive aspects of querying the transcorder database is provided below:

<?PHP
header(′Content-Type: text/plain′);
function codec_query($format, $DBserver, $password) {
mysql_connect(“204.192.85.202”,$DBserver,$password); // access
database server
mysql_select_db(“TRANSCODE.SQL”); // select database table to
search
//create query for code for camera media of type $header
$query = “SELECT codec_id_codec_name_codec_file FROM
CodecTable WHERE

media_type LIKE ′%′ $format”;

$result = mysql_query($query); // perform the search query
mysql_close(“TRANSCODE.SQL”); // close database access
return $result; // return search result
?>

In response to the query, the transcoder database may provide 304 the requested data, which may include, but not be limited to: codec ID, codec name, a codec module, and/or the like. The media conversion server may utilize the codec module provided by the transcoder database and transcode 305 the received media from the camera-dependent format into a scalable 3D media format using the codec module. For example, the media conversion server may convert the camera media into a WebM file including video channels encoded according to the V8 video compression format and audio channels encoded according to the Vorbis audio format specification. The media conversion server may provide 306 the transcoded 3D SMF-formatted media to the streaming server. The streaming server may store 307 the received SMF-formatted media in buffer memory or in the streaming media database.

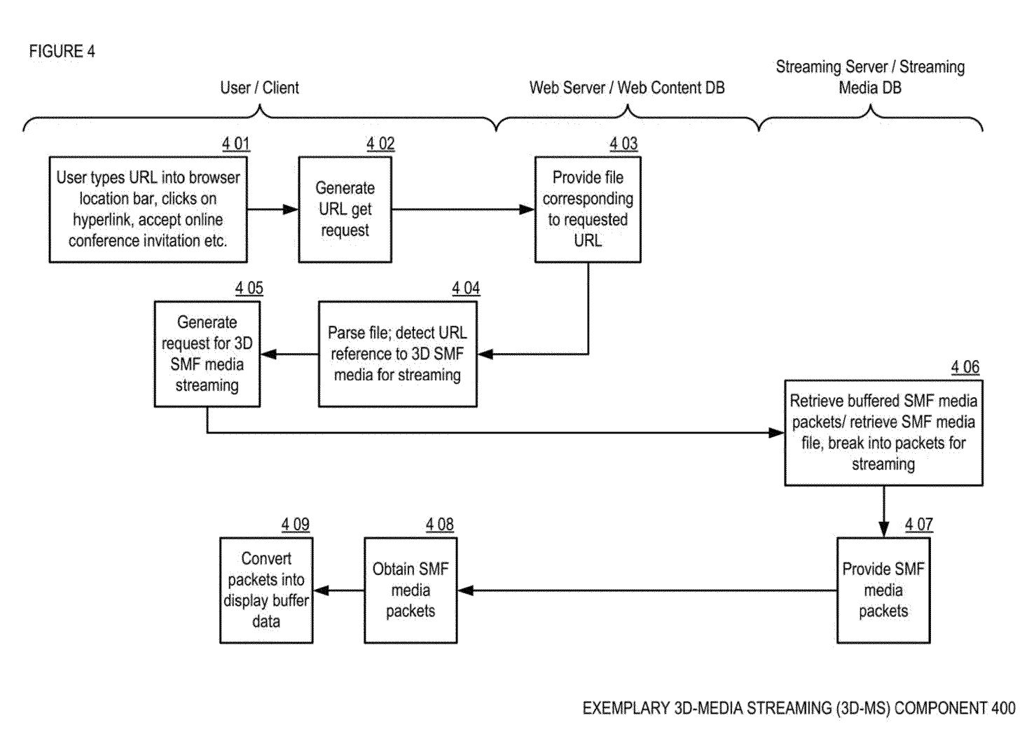

FIG. 4 is of a logic flow diagram illustrating exemplary aspects of on-demand client-independent network streaming of three-dimensional (“3D”) media content in some embodiments of the 3D-WCP, e.g., a 3D-media streaming (“3D-MS”) component 400. In some implementations, the user may type in a URL into a web browser or activate a hyperlink directed to a URL 401. The browser may generate a URL get request 402, and provide the URL get request to the web server. The web server, in response to the URL get request, may retrieve and provide 403 the file corresponding to the URL. The client, upon receiving the file from the web server, may parse 404 the file and render a web page on the display screen of the client based on the file parsing. For example, a browser executing on the client may parse the received file, and render the web page for display on the display device connected to the client. The client may, in some implementations, also detect (e.g., 404) the presence in the parsed file of a reference to a 3D SMF-formatted media object stored on the streaming server and/or streaming database. The client may then generate 405 a request for 3D SMF media streaming (e.g., handshaking protocols) with the streaming server to stream the 3D SMF-formatted media from the streaming server and/or streaming database to the client. Upon receiving the client-generated request, the streaming server may obtain 406 the media to be streamed from the buffer memory and/or streaming database, and if needed, break the media data into packets for streaming transmission to the client (e.g., via HTTP(S) streaming). The streaming server may stream 407 the 3D SMF-formatted media packets to the client. Upon obtaining 408 the streamed media packets, the client may organize the packets using timestamps associated with the packets, convert 409 the received packets into display buffer data, and store the display data in a buffer memory of the client.

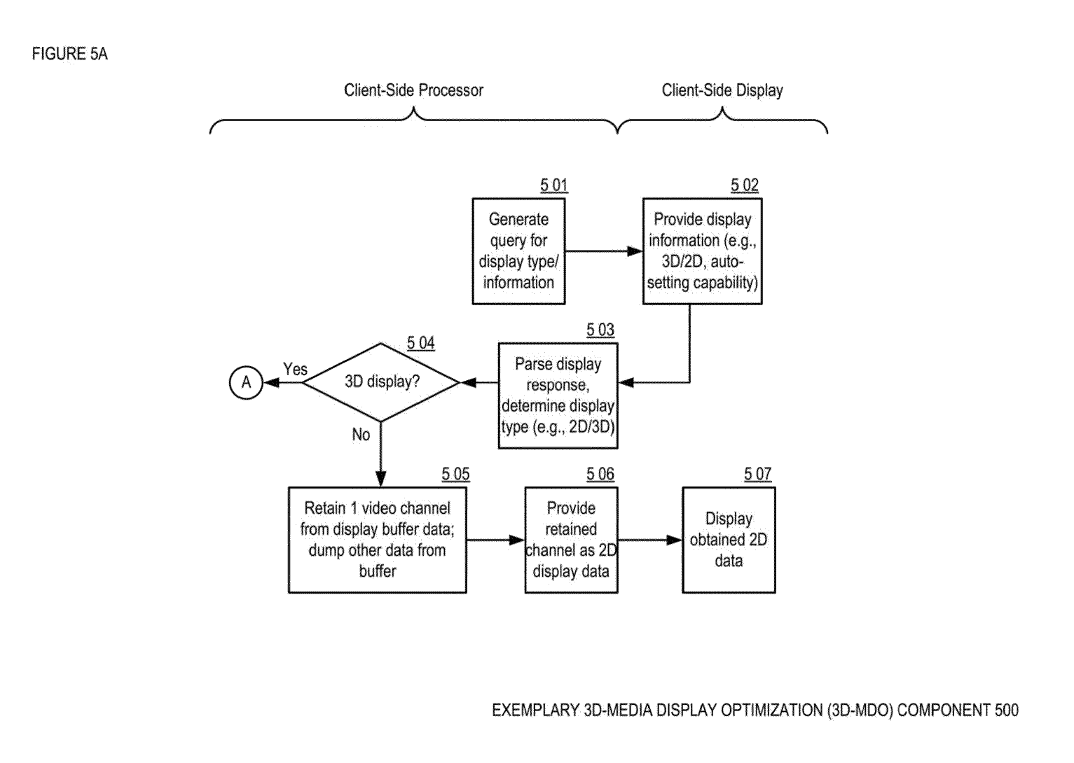

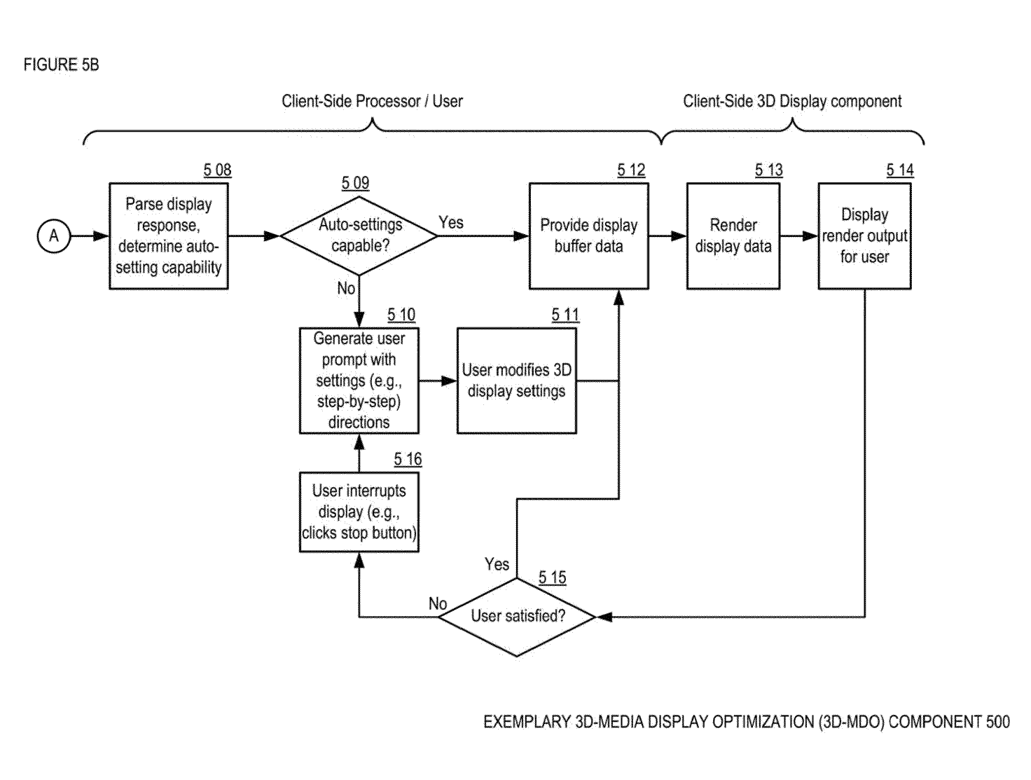

FIGS. 5A-B are of logic flow diagrams illustrating exemplary aspects of optimizing settings of a client-side streamed 3D media display in some embodiments of the 3D-WCP, e.g., a 3D-media display optimization (“3D-MDO”) component 500. In some implementations, the client may attempt to optimize the 3D viewing experience of the user when consuming the 3D media streamed from the streaming server to the client. Various displays utilized to perform rasterization of 3D media content may operate in various different manners on the obtained SMF-formatted media content. Accordingly, in some implementations, the client may attempt to calibrate the display of the 3D media content using interactive user feedback. In some implementations, the client-side processor (e.g., GPU) may request 501 the display for identification data and/or information about the display. The display may respond 502 with information on the display characteristics, including, but not limited to: display name, display type, display ID, 2D/3D capable, auto configure capabilities, resolution, frame rate, contrast ratio, and/or the like. The client-side processor may parse 503 the response from the display and determine whether the display is capable of presenting 3D media to the user. If the processor determines that the display is not capable of presenting 3D media (e.g., 504, Option No), the client-side processor may convert 505 the 3D media into 2D media (e.g., by dumping all video channels but one from the media stream). The client-side processor may provide the 2D media 506 for the display. The display may rasterize and/or project 507 the provided 2D media for the user upon receiving the 2D media.

In some implementations, the display may indicate that it is capable of handling 3D media (e.g., 504, Option Yes). In such implementations, the client-side processor may parse 508 the display's response, and determine 509 whether the display is capable of automatically adjusting its settings for the provided 3D media. If the display is capable of automatically adjusting its setting (e.g., 509, Option Yes), the client-side processor may provide 512 the 3D media directly to the display device. The display device may render 513 the provided 3D display data and provide 514 the rendered 3D projection for the user. In some implementations, the user may not be satisfied (e.g., 515 Option No) with the automatically adjusted settings of the display, and may wish to adjust the display settings manually. The user may then interrupt 516 the display in order to adjust the display settings. In other implementations, the display may indicate to the client-side processor that it is not capable of automatically adjusting its setting (e.g., 509 Option No). In such implementations, the client-side processor may generate user prompts 510 (e.g., 2D dialog boxes, etc.) providing the user by step-by-step instructions (e.g., walking the user through the manual settings process). The user may modify 511 the settings according to the step-by-step instructions provided by the client-side processor. The client-side processor, if needed, (re)initiate the 3D display, and provide the 3D media to the display. The 3D-WCP may engage in an iterative display optimization procedure until the user is satisfied with the 3D projection experience.

### 3D-WCP Controller

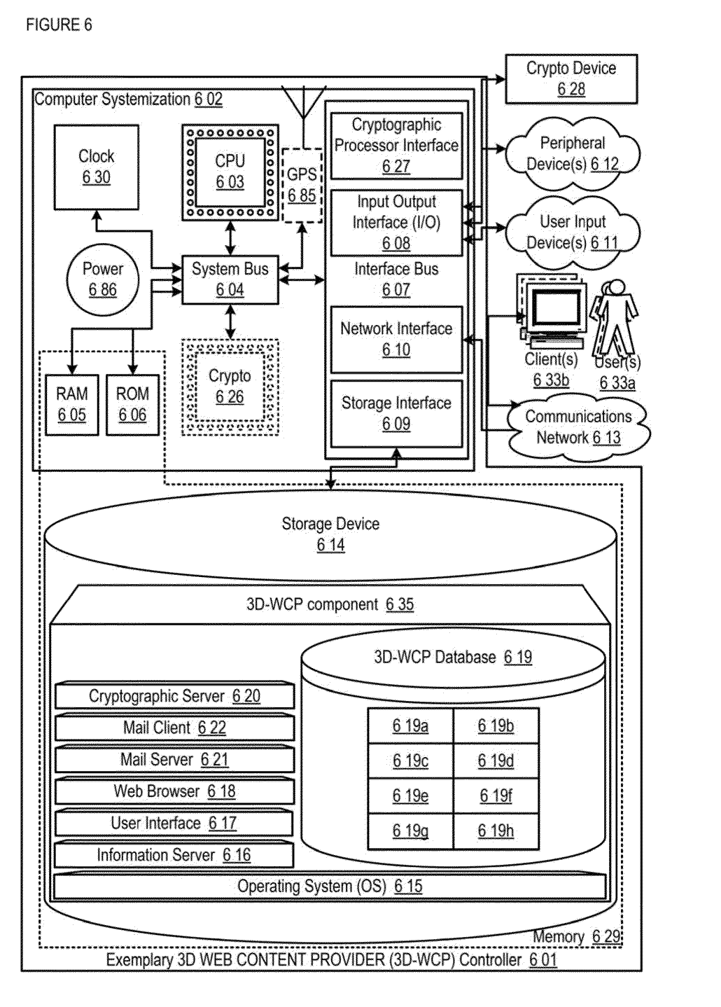

FIG. 6 illustrates inventive aspects of a 3D-WCP controller 601 in a block diagram. In this embodiment, the 3D-WCP controller 601 may serve to aggregate, process, store, search, serve, identify, instruct, generate, match, and/or facilitate interactions with a computer through enterprise and human resource management technologies, and/or other related data.

Typically, users, which may be people and/or other systems, may engage information technology systems (e.g., computers) to facilitate information processing. In turn, computers employ processors to process information; such processors 603 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 629 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the 3D-WCP controller 601 may be connected to and/or communicate with entities such as, but not limited to: one or more users from user client devices 611; peripheral devices 612; an optional cryptographic processor device 628; and/or a communications network 613. For example, the 3D-WCP controller 601 may be connected to and/or communicate with users operating client device(s) including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™ etc.), eBook reader(s) (e.g., Amazon Kindle™ etc.), laptop computer(s), notebook(s), netbook(s), gaming console(s) (e.g., XBOX Live™, Nintendo® DS etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The 3D-WCP controller 601 may be based on computer systems that may comprise, but are not limited to, components such as: a computer systemization 602 connected to memory 629.

### Computer Systemization

A computer systemization 602 may comprise a clock 630, central processing unit (“CPU(s)” and/or “processor(s)” (these terms are used interchangeable throughout the disclosure unless noted to the contrary)) 603, a memory 629 (e.g., a read only memory (ROM) 606, a random access memory (RAM) 605, etc.), and/or an interface bus 607, and most frequently, although not necessarily, are all interconnected and/or communicating through a system bus 604 on one or more (mother)board(s) 602 having conductive and/or otherwise transportive circuit pathways through which instructions (e.g., binary encoded signals) may travel to effect communications, operations, storage, etc. Optionally, the computer systemization may be connected to an internal power source 686. Optionally, a cryptographic processor 626 may be connected to the system bus. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 529 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the 3D-WCP controller and beyond through various interfaces. Should processing requirements dictate a greater amount speed and/or capacity, distributed processors (e.g., Distributed 3D-WCP), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the 3D-WCP may be achieved by implementing a microcontroller such as CAST's R8051XC2 microcontroller; Intel's MCS 51 (i.e., 8051 microcontroller); and/or the like. Also, to implement certain features of the 3D-WCP, some feature implementations may rely on embedded components, such as: Application-Specific integrated Circuit (“ASIC”), Digital Signal Processing (“DSP”), Field Programmable Gate Array (“FPGA”), and/or the like embedded technology. For example, any of the 3D-WCP component collection (distributed or otherwise) and/or features may be implemented via the microprocessor and/or via embedded components; e.g., via ASIC, coprocessor, DSP, FPGA, and/or the like. Alternately, some implementations of the 3D-WCP may be implemented with embedded components that are configured and used to achieve a variety of features or signal processing.

Depending on the particular implementation, the embedded components may include software solutions, hardware solutions, and/or some combination of both hardware/software solutions. For example, 3D-WCP features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the 3D-WCP features. A hierarchy of programmable interconnects allow logic blocks to be interconnected as needed by the 3D-WCP system designer/administrator, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the 3D-WCP may be developed on regular FPGAs and then migrated into a fixed version that more resembles ASIC implementations. Alternate or coordinating implementations may migrate 3D-WCP controller features to a final ASIC instead of or in addition to FPGAs. Depending on the implementation all of the aforementioned embedded components and microprocessors may be considered the “CPU” and/or “processor” for the 3D-WCP.

### Power Source

The power source 686 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 686 is connected to at least one of the interconnected subsequent components of the 3D-WCP thereby providing an electric current to all subsequent components. In one example, the power source 686 is connected to the system bus component 604. In an alternative embodiment, an outside power source 686 is provided through a connection across the I/O 608 interface. For example, a USB and/or IEEE 1394 connection carries both data and power across the connection and is therefore a suitable source of power.

### Interface Adapters

Interface bus(ses) 607 may accept, connect, and/or communicate to a number of interface adapters, conventionally although not necessarily in the form of adapter cards, such as but not limited to: input output interfaces (I/O) 608, storage interfaces 609, network interfaces 610, and/or the like. Optionally, cryptographic processor interfaces 627 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) industry Standard Architecture ((E)ISA), Micro Channel Architecture (MCA), Nu Bus, Peripheral Component Interconnect (Extended) (PCI(X)), PCI Express, Personal Computer Memory Card International Association (PCMCIA), and/or the like.

Storage interfaces 609 may accept, communicate, and/or connect to a number of storage devices such as, but not limited to: storage devices 614, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 610 may accept, communicate, and/or connect to a communications network 613. Through a communications network 613, the 3D-WCP controller is accessible through remote clients 633b (e.g., computers with web browsers) by users 633a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed 3D-WCP), architectures may similarly be employed to pool, load balance, and/or otherwise increase the communicative bandwidth required by the 3D-WCP controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 610 may be used to engage with various communications network types 613. For example, multiple network interfaces may be employed to allow for the communication over broadcast, multicast, and/or unicast networks.

Input Output interfaces (I/O) 608 may accept, communicate, and/or connect to user input devices 611, peripheral devices 612, cryptographic processor devices 628, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless: 802.11a/b/g/n/x, Bluetooth, code division multiple access (CDMA), global system for mobile communications (GSM), WiMax, etc.; and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 611 may be card readers, dongles, finger print readers, gloves, graphics tablets, joysticks, keyboards, mouse (mice), remote controls, retina readers, trackballs, trackpads, and/or the like.

Peripheral devices 612 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality); goggles, microphones, monitors, network interfaces, printers, scanners, storage devices, video devices, video sources, visors, and/or the like.

It should be noted that although user input devices and peripheral devices may be employed, the 3D-WCP controller may be embodied as an embedded, dedicated, and/or monitor-less (i.e., headless) device, wherein access would be provided over a network interface connection.

Cryptographic units such as, but not limited to, microcontrollers, processors 626, interfaces 627, and/or devices 628 may be attached, and/or communicate with the 3D-WCP controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+ MB/s of cryptographic instructions; VLSI Technology's 33 MHz 6868; and/or the like.

### Memory

Generally, any mechanization and/or embodiment allowing a processor to affect the storage and/or retrieval of information is regarded as memory 629. However, memory is a fungible technology and resource, thus, any number of memory embodiments may be employed in lieu of or in concert with one another. It is to be understood that the 3D-WCP controller and/or a computer systemization may employ various forms of memory 629. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory 629 will include ROM 606, RAM 605, and a storage device 614. A storage device 614 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 629 may contain a collection of program and/or database to components and/or data such as, but not limited to: operating system component(s) 615 (operating system); information server component(s) 616 (information server); user interface component(s) 617 (user interface); Web browser component(s) 618 (Web browser); database(s) 619; mail server component(s) 621; mail client component(s) 622; cryptographic server components) 620 (cryptographic server); the 3D-WCP component(s) 635; and/or the like (i.e., collectively a component collection). These components may be stored and accessed from the storage devices and/or from storage devices accessible through an interface bus. Although non-conventional program components such as those in the component collection, typically, are stored in a local storage device 614, they may also be loaded and/or stored in memory such as: peripheral devices, RAM, remote storage facilities through a communications network, ROM, various forms of memory, and/or the like.

### Operating System

The operating system component 615 is an executable program component facilitating the operation of the 3D-WCP controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the 3D-WCP controller to communicate with other entities through a communications network 613. Various communication protocols may be used by the 3D-WCP controller as a subcarrier transport mechanism for interaction, such as, but not limited to: multicast, TCP/IP, UDP, unicast, and/or the like.

### Information Server

An information server component 616 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (DMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the 3D-WCP controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the 3D-WCP database 619, operating systems, other program components, user interfaces, Web browsers, and/or the like.

Access to the 3D-WCP database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the 3D-WCP. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the 3D-WCP as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Attorney Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQueiy(UI), MooTools, Prototype, script.aculo.us, SWFObject, Yahoo! User Interface, any of which may be used and) provide a baseline and means of accessing And displaying information graphically to users.

A user interface component 617 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 618 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the 3D-WCP enabled nodes. The combined application may be nugatory on systems employing standard Web browsers.

### Mail Server

A mail server component 621 is a stored program component that is executed by a CPU 603. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the 3D-WCP.

Access to the 3D-WCP mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 622 is a stored program component that is executed by a CPU 603. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 620 is a stored program component that is executed by a CPU 603, cryptographic processor 626, cryptographic processor interface 627, cryptographic processor device 628, and/or the like. Cryptographic processor interfaces will allow for expedition of encryption and/or decryption requests by the cryptographic component; however, the cryptographic component, alternatively, may run on a conventional. CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the 3D-WCP may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the 3D-WCP component to engage in secure transactions if so desired. The cryptographic component facilitates the secure accessing of resources on the 3D-WCP and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The 3D-WCP Database

The 3D-WCP database component 619 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the 3D-WCP database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the 3D-WCP database is implemented as a data-structure, the use of the 3D-WCP database 619 may be integrated into another component such as the 3D-WCP component 635. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 619 includes several tables 619a-h. A Users table 619a may include fields such as, but not limited to: user_ID, first_name, last_name, middle_name, suffix, prefix, device_ID_list, device_name_list, device_type_list, hardware_configuration_list, software_apps_list, device_IP_list, device_MAC_list, device_preferences_list, and/or the like. A Camera Media table 619b may include fields such as, but not limited to: device_ID, device_name, device_type media_format, and/or the like. A Codecs table 619c may include fields such as, but not limited to: codec_ID, codec_name, codec_type, codec_version, code_version_timestamp, codec_compatibilities_hw, codec_compatibilities_sw, and/or the like. A Streaming Media table 619d may include fields such as, but not limited to: streaming_protocol, streaming_rate, stream_no, stream_ID, and/or the like. A Host Server table 619e may include fields such as, but not limited to: user_id, user_name, app_id, app_name, api_list, api_function_list, client_id, language_pref, and/or the like. A Computing Server table 619f may include fields such as, but not limited to: job_id, job_app_server_id, user_id, user_data, and/or the like. A Web Server table 619g may include fields such as, but not limited to: page_id, page_name, page_versions, page_update_schedule, and/or the like. A Client table 619h may include fields such as, but not limited to: user_id, user_name, client_ip_address, client_type, and/or the like. One or more of the tables discussed above may support and/or track multiple entity accounts on a 3D-WCP.

In one embodiment, the 3D-WCP database may interact with other database systems. For example, employing a distributed database system, queries and data access by search 3D-WCP component may treat the combination of the 3D-WCP database, an integrated data security layer database as a single database entity.

In one embodiment, user programs may contain various user interface primitives, which may serve to update the 3D-WCP. Also, various accounts may require custom database tables depending upon the environments and the types of clients the 3D-WCP may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 619a-h. The 3D-WCP may be configured to keep track of various settings, inputs, and parameters via database controllers.

The 3D-WCP database may communicate to and/or with other components in a component collection, including itself, and/or facilities of the like. Most frequently, the 3D-WCP database communicates with the 3D-WCP component, other program components, and/or the like. The database may contain, retain, and provide information regarding other nodes and data.

### The 3D-WCPs

The 3D-WCP component 635 is a stored program component that is executed by a CPU. In one embodiment, the 3D-WCP component incorporates any and/or all combinations of the aspects of the 3D-WCP discussed in the previous figures. As such, the 3D-WCP affects accessing, obtaining and the provision of information, services, transactions, and/or the like across various communications networks.

The 3D-WCP component enables on-demand client-independent network streaming of three-dimensional (“3D”) media content, and/or the like and use of the 3D-WCP. In one embodiment, the 3D-WCP component 635 takes inputs (e.g., 3D media 211, user input 214, codecs from transcoder DB, web content from web content DB, and/or the like) etc., and transforms the inputs via various components (e.g., 3D-MT 300, 3D-MS 400, 3D-MDO 500, and/or the like), into outputs (e.g., camera3D media in camera-dependent format 211, standardized 3D media 313, URL get request 216, URL web page 217, media request 219, 3D media stream 220, 3D media display 222, and/or the like), as shown in FIGS. 2-5B, as well as throughout the specification.

The 3D-WCP component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the 3D-WCP server employs a cryptographic server to encrypt and decrypt communications. The 3D-WCP component may communicate to and/or with other components in a component collection, including itself, and/or facilities of the like. Most frequently, the 3D-WCP component communicates with the 3D-WCP database, operating systems, other program components, and/or the like. The 3D-WCP may contain, communicate, generate, obtain, and/or provide program component, system, user, and/or data communications, requests, and/or responses.

### Distributed 3D-WCPs

The structure and/or operation of any of the 3D-WCP node controller components may be combined, consolidated, and/or distributed in any number of ways to facilitate development and/or deployment. Similarly, the component collection may be combined in any number of ways to facilitate deployment and/or development. To a accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques. For example, 3D-WCP server(s) and database(s) may all be localized within a single computing terminal. As another example, the 3D-WCP components may be localized within one or more entities (e.g., hospitals, pharmaceutical companies etc.) involved in coordinated patient management.

The configuration of the 3D-WCP controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), local and remote application program interfaces Jini, Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between components. For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or other wise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., the SOAP parser) that may be employed to parse communications data. Further, the parsing grammar may be used beyond message parsing, but may also be used to parse: databases, data collections, data stores, structured data, and/or the like. Again, the desired configuration will depend upon the context, environment, and requirements of system deployment.

In order to address various issues and improve over the prior art, the invention is directed to apparatuses, methods and systems for a mobile healthcare management system. The entirety of this application (including the Cover Page, Title, Headings, Field, Background, Summary, Brief Description of the Drawings, Detailed Description, Claims, Abstract, Figures, Appendices and/or otherwise) shows by way of illustration various embodiments in which the claimed inventions may be practiced. The advantages and features of the application are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims. It is to be understood that, depending on the particular needs of the 3D-WCP and/or characteristics of the hardware, software, network framework, monetization model and/or the like, various embodiments of the 3D-WCP may be implemented that enable a great deal of flexibility and customization. It is to be understood that, depending on the particular needs of the 3D-WCP and/or characteristics of the hardware, software, network framework, monetization model and/or the like, various embodiments of the 3D-WCP may be implemented that enable a great deal of flexibility and customization. The instant disclosure discusses example implementations of the 3D-WCP within the context of online media viewing. However, it is to be understood that the system described herein can be readily configured for a wide range of other applications and/or implementations. For example, implementations of the 3D-WCP can be configured to operate within the context of videoconferencing, social and/or professional networking, and/or the like. Alternate implementations of the system may be utilized in various contexts outside online media viewing, including, but not limited to: office productivity/collaboration, distributed online advertising, networked surveillance systems, scientific research equipment, and/or the like. It is to be understood that the 3D-WCP may be further adapted to other implementations.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

What is claimed is:

1. A 3D-media streaming processor-implemented method, comprising:
obtaining a three-dimensional display media object encoded in a camera-dependent media format;
transcoding via a processor the obtained display media object into a transcoded three-dimensional display media object encoded in a device-independent scalable media format;
obtaining a request for the transcoded three-dimensional display media object from a client device; and
streaming the transcoded three-dimensional display media object to the client device.

2. A 3D media consumption processor-implemented method, comprising:
providing a request for a network resource;
obtaining a web page in response to providing the request for the network resource;
parsing the obtained web page for rendering a display for a user;
identifying a reference to a three-dimensional display media object in the web page based on parsing the web page;
providing a request for the referenced three-dimensional display media object;
obtaining a stream comprising media from the three-dimensional display media object, the stream encoded according to a device-independent scalable media format upon providing the request; and
providing a three-dimensional projection using the obtained stream.
